(19) United States
(12) Patent Application Publication
(10) Pub. No.: US 2015/0300259 A1
(43) Pub. Date: Oct. 22, 2015

(54) AIRCRAFT ENGINE

(71) Applicant: MTU Aero Engines AG, Munich (DE)

(72) Inventors: Nicolas THOUAULT, Munich (DE); Martin HOEGER, Erding (DE)

(21) Appl. No.: 14/692,050

(22) Filed: Apr. 21, 2015

(30) Foreign Application Priority Data
Apr. 22, 2014 (DE) 102014207547.5

(51) Int. Cl. F02C 7/20; B64D 33/04

(52) U.S. Cl. CPC F02C 7/20; B64D 33/04

(57) ABSTRACT

The invention relates to an aircraft engine having an outlet housing (12) arranged downstream of a low-pressure turbine (10) and having at least one follow-up guide ring (16) which is arranged within an annular chamber (14) of the outlet housing (12) and which serves for diverting a swirling hot-gas flow (18) emerging from the low-pressure turbine (10). The follow-up guide ring (16) comprises at least one blade (20) which is arranged in the annular chamber (14) and has an upstream leading edge (22), which leading edge (22) is designed such that, from its radially inner end in the direction of a radially externally situated housing wall (24) of the outlet housing (14), it runs so as to advance in the downstream direction. In this case, the leading edge (22) is configured so as to run at an angle ε of from 15° to 35° with respect to a radial line r that lies on a plane (38) formed perpendicular to an engine axis (26).

### CROSS-REFERENCE TO RELATED APPLICATIONS

The present application claims priority under 35 U.S.C. §119 of German Patent Application No. 102014207547.5, filed Apr. 22, 2014, the entire disclosure of which is expressly incorporated by reference herein.

### BACKGROUND OF THE INVENTION

1. Field of the Invention The invention relates to an aircraft engine having an outlet housing arranged downstream of a low-pressure turbine and having at least one follow-up guide ring which is arranged within an annular chamber of the outlet housing and which serves for diverting a swirling hot-gas flow emerging from the low-pressure turbine, wherein the follow-up guide ring comprises at least one blade which is arranged in the annular chamber and which has an upstream leading edge, and the leading edge is designed such that, in the direction of a radially externally situated housing wall of the outlet housing, it runs so as to advance in the downstream direction.

2. Discussion of Background Information Follow-up guide rings of said type (so-called TEC, Turbine Exit Casing) are known, for example from U.S. Pat. No. 4,685,286 A1, the entire disclosure of which is incorporated by reference herein. In aircraft engines, the installation of a static follow-up guide ring gives rise to increases in pressure by virtue of swirl being removed from the outflow of hot air, and thus the propulsion efficiency being improved. A follow-up guide ring normally comprises multiple blades which may be formed so as to be swept rearward, that is to say formed with a leading edge which, from its radially inner end in the direction of a radially externally situated housing wall of the follow-up guide ring, advances in the downstream direction. Owing to the swept configuration, greater decelerations at the engine hub of the follow-up guide ring are possible, and furthermore, it is possible for aerodynamic losses to be reduced. However, it remains a disadvantage of known aircraft engines with a follow-up guide ring positioned downstream of a low-pressure turbine in the flow direction that the interaction between a final rotor of the low-pressure turbine and the follow-up guide ring constitutes a source of intense noise, which is a disadvantage for the operation of the aircraft engine as a whole.

It would therefore by advantageous to be able to provide an aircraft engine of the type mentioned in the introduction which is distinguished by reduced generation of noise.

### SUMMARY OF THE INVENTION

The present invention provides an aircraft engine having the features recited in the instant independent claim. The dependent claims specify advantageous embodiments with expedient refinements of the invention.

An aircraft engine according to the invention has an outlet housing arranged downstream of a low-pressure turbine and has a follow-up guide ring which is arranged within an annular chamber of the outlet housing and which serves for diverting a swirling hot-gas flow emerging from the low-pressure turbine, wherein the follow-up guide ring comprises at least one blade which is arranged in the annular chamber and which has an upstream leading edge, and the leading edge is designed such that, from its radially inner end in the direction of a radially externally situated housing wall of the annular chamber, it runs so as to advance in the downstream direction. In this case, the leading edge is configured so as to run at an angle ε of between 15° and 35° with respect to a radial line r that lies on a plane formed perpendicular to an engine axis. The angle ε may for example assume the following values: 15°, 16°, 17°, 18°, 19°, 20°, 21°, 22°, 23°, 24°, 25°, 26°, 27°, 28°, 29°, 30°, 31°, 32°, 33°, 34°, 35° or corresponding intermediate values. It has surprisingly been found that, aside from the aerodynamic advantages of such a configuration of the leading edge of the blade of the follow-up guide ring in the angular range between 15° and 35°, that is to say with the follow-up guide ring being correspondingly swept rearward axially, a considerable reduction of the noise generated by the interaction between the final rotor of the low-pressure turbine and the follow-up guide ring is attained. The swept configuration of the blade of the follow-up guide ring according to the invention has the effect that, over a predominant part of the leading edge, there is an increased distance between the follow-up guide ring and the final turbine rotor. In this way, disruptions can abate more effectively, such that the noise of the interaction between rotor and follow-up guide ring can be considerably reduced. The noise contribution of the low-pressure turbine to the noise of the corresponding aircraft engine can be significantly reduced. Since less noise is emitted to the outside by the low-pressure turbine, it is possible, in principle, for the rotational speed of the low-pressure turbine to be increased without the admissible noise pollution limit being exceeded. This in turn leads to an increase in efficiency of the low-pressure turbine, and possibly to a reduction in weight of the turbine, as fewer stages are required in order to attain predefined power ranges. Furthermore, the swept configuration according to the invention of the at least one blade of the follow-up guide ring yields aerodynamic advantages because, owing to the rearwardly advancing leading edge, secondary flows are reduced. Owing to the rearwardly swept configuration, it is furthermore the case that greater decelerations are possible at the hub of the engine, such that overall, the low-pressure turbine of the aircraft engine can be configured so as to be quieter, more efficient and more lightweight. Furthermore, an efficient diversion of the hot-gas flow emerging from the low-pressure turbine by the follow-up guide ring is ensured. It is advantageously possible, with the same follow-up guide ring outlet cross section, to realize smaller rotor heights in the low-pressure turbine and a higher outlet Mach number at the rotor, wherein it is in turn advantageously possible for more power to be converted in the highly efficient final stage of the low-pressure turbine.

In an advantageous refinement of the aircraft engine according to the invention, the angle ε is about 20° to about 30°, in particular about 25°. A particularly pronounced reduction in noise can be attained in this angle range of the swept configuration.

It has furthermore proven to be advantageous for a ratio of a maximum axial extent to a maximum radial extent of the at least one blade of the follow-up guide ring to be relatively small in relation to the follow-up guide ring blades known from the prior art, specifically less than 0.6, preferably approximately 0.5. It is pointed out that the axial extent of the blade in a radial direction, that is to say in a direction orthogonal with respect to the engine axis, may vary Likewise, the radial extent of the blade in an axial direction, that is to say in a direction parallel to the engine axis, may vary. By virtue of the blades being designed to be relatively short in the axial direction in relation to the radial extent thereof, the follow-up guide ring as a whole can be designed to be relatively short, and in particular, requires no more axial installation space than conventional follow-up guide rings, the blades of which do not have leading edges which are configured so as to run at an angle of between 15° and 35° with respect to a radial line that lies on a plane formed perpendicular to an engine axis.

In order that substantially the same loads can be transmitted between the radially outer housing and hub by means of the blades, which are of more filigree form in comparison to the blades of conventional follow-up guide rings, it is furthermore advantageous if a ratio of a number of blades of the follow-up guide ring to a number of blades of a rotor, which is directly adjacent to the follow-up guide ring in an upstream direction, of the low-pressure turbine is greater than 0.3, preferably greater than 0.5, more preferably greater than 0.6, and even more preferably approximately 0.7. In other words, the follow-up guide ring preferably has a considerably greater number of blades than the final rotor, or final rotor stage, of the low-pressure turbine of the aircraft engine as viewed in the flow direction.

The use of a relatively large number of blades, which are of relatively short form in an axial direction, in the follow-up guide ring in comparison to the prior art is promoted in particular if the blades of the follow-up guide ring have no supply lines. In the prior art, the blades of the follow-up guide ring are often in the form of hollow blades through which supply lines, for example for the supply of oil, are led. In the case of the aircraft engine according to the invention, it is instead possible for the required supply lines to be led through guide grates which are arranged upstream of the low-pressure turbine, for example through the so-called Turbine Center Frame (TCF) or Turning Mid Turbine Frame (TMTF). In this way, it is possible for the blades in the follow-up guide ring of the aircraft engine according to the invention to be of smaller form, which makes it possible, despite the advantages described above that are associated with the rearwardly swept configuration according to the invention of the leading edge, for the installation space required for the follow-up guide ring, in particular in an axial direction, to be not increased or to be at least not significantly increased, or even to be reduced, overall.

In a further advantageous embodiment of the aircraft engine according to the invention, a profile axis of the annular chamber of the outlet housing is formed so as to be inclined from the low-pressure turbine in the direction of the engine axis. In this way, it is possible for the outlet housing and the follow-up guide ring to be of short overall form. By virtue of the fact that the annular chamber runs radially inward in the direction of the engine axis, it is furthermore possible for the annular chamber, situated between the outlet housing or the outlet duct of the follow-up guide ring and the engine axis, of the hub of the aircraft engine to be advantageously shortened. In this case, the “profile axis of the annular chamber” is to be understood to mean an axis generated if, in a section plane encompassing the engine axis, in the region of the annular chamber, a line is drawn between the radially externally situated housing wall of the outlet housing and the radially internally situated housing wall of the outlet housing, which housing walls together delimit the annular chamber in a radial direction, wherein, in this section plane, the line is equidistant from the radially externally situated housing wall of the outlet housing and from the radially internally situated housing wall of the outlet housing over the entire axial length of the outlet housing, and if said line is subsequently approximated by a straight center line. Said straight center line then forms the profile axis of the annular chamber, which in this case is always in relation to a specific section plane. Over the entire circumference of the annular chamber, all of the profile axes of the annular chamber together form, in the region of the annular chamber, a frustum which tapers along the flow direction in the region of the annular chamber, since the individual profile axes of the annular chamber of the outlet housing are formed so as to be inclined from the low-pressure turbine in the direction of the engine axis in this further advantageous embodiment of the aircraft engine according to the invention.

In further advantageous embodiments of the aircraft engine according to the invention, the blade of the follow-up guide ring is of profiled form in cross section. In particular, it is possible for the leading edge of the blade to be of rounded form. It is advantageously possible for the blade to be profiled in accordance with requirements, in particular the aerodynamic requirements in the corresponding engine region. In this case, the blade of the follow-up guide ring is preferably profiled so as to effect an efficient diversion of the hot-gas flow, in particular a reduction of the swirl of the hot-gas flow, at least in regions.

In further advantageous embodiments of the aircraft engine according to the invention, a radially outer end of the blade is arranged at an inner side of the radially externally situated housing wall of the annular chamber, and/or a radially inner end of the blade is arranged at an inner side of a radially internally situated housing wall of the annular chamber. In this case, the respective ends of the blade may be connected to and/or formed integrally with the corresponding inner sides. It is normally furthermore the case that at least two blades are arranged symmetrically in the annular chamber of the outlet housing in order to form the follow-up guide ring. If the follow-up guide ring is configured with a relatively high number of blades, this yields short chord lengths and slim structural forms, made possible in particular by the configuration according to the invention of the blades.

In further advantageous embodiments of the aircraft engine according to the invention, the angle ε is constant over the entire length of the leading edge or varies in sections.

This means that the angle of the leading edge with respect to a radial line lying on a plane formed perpendicular to the engine axis may remain constant over the entire length of the leading edge, or varies in continuous or discontinuous fashion. In this case, however, the angle ε always lies between 15° and 35°. The leading edge of the blade of the follow-up guide ring can advantageously be varied and adapted in accordance with the structural and aerodynamic circumstances.

### BRIEF DESCRIPTION OF THE DRAWINGS

The invention will now be described in more detail, with reference to the accompanying drawings. In the drawings:

FIG. 1 is a diagrammatic illustration of a turbine outlet region of an aircraft engine according to the prior art;

FIG. 2 is a diagrammatic illustration of a turbine outlet region of an aircraft engine according to the invention;

FIG. 3 is an illustration of the profile of the acoustic power, generated by the interaction between a final rotor of the low-pressure turbine and the follow-up guide ring, in relation to the magnitude of the axially swept configuration (angle ε) of a leading edge of a blade of a follow-up guide ring; and

FIG. 4 shows a cross section of a blade of a follow-up guide ring of the aircraft engine according to the invention.

### DETAILED DESCRIPTION OF ILLUSTRATIVE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description in combination with the drawings making apparent to those of skill in the art how the several forms of the present invention may be embodied in practice.

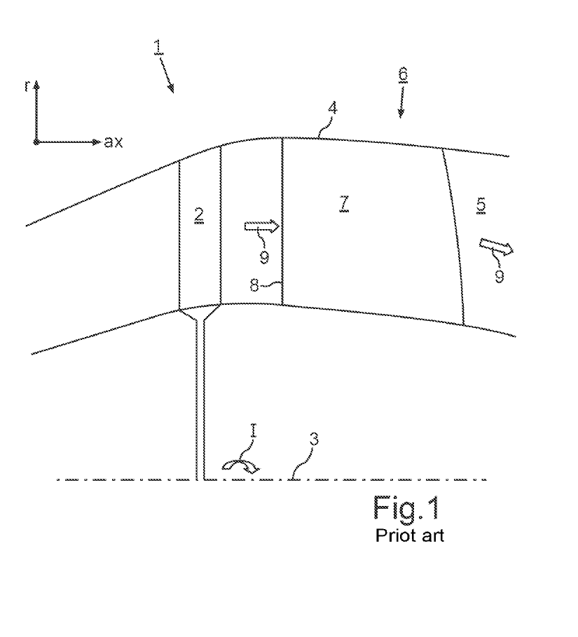

FIG. 1 shows a diagrammatic illustration of a known aircraft engine in the region of a turbine outlet of a low-pressure turbine 1. The figure shows an annular chamber 5 of an outlet housing 4, which annular chamber is arranged downstream of a final rotor 2 of the low-pressure turbine 1 of the aircraft engine, wherein the rotor 2 rotates, as per arrow I, about an axis of rotation, specifically the engine axis 3. The flow direction of the operating fluid is denoted by the arrows 9. In the annular chamber 5 there is arranged a known follow-up guide ring 6, also referred to as TEC. The follow-up guide ring 6 comprises multiple blades 7 arranged annularly in the annular chamber 5, said blades each having a leading edge 8 and a trailing edge as viewed in the flow direction 9. It can be seen that, in this specific example from the prior art, the leading edge 8 runs approximately parallel to a radial line r lying on a plane formed perpendicular to the engine axis 3. The profile of the axial engine axis 3 is denoted by ax.

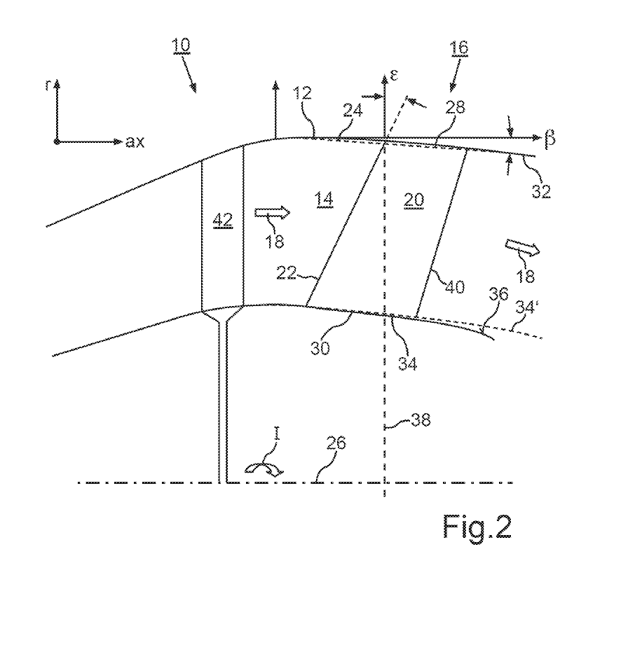

FIG. 2 shows a diagrammatic illustration of a turbine outlet region of an aircraft engine with a low-pressure turbine 10. In this case, a rotor 42 of the low-pressure turbine 10 is illustrated. The rotor 42 constitutes the final rotor of the low-pressure turbine 10 as viewed in the flow direction 18 and rotates, as per arrow I, about an axis of rotation, specifically an engine axis 26 of the aircraft engine. It can furthermore be seen that the low-pressure turbine 10 is followed, downstream, by an outlet housing 12, wherein the outlet housing 12 comprises an annular chamber 14. The annular chamber 14 forms the outlet duct for the hot-gas flow 18. The flow direction of the hot-gas flow 18 is denoted by corresponding arrows.

Within the annular chamber 14 there is arranged a follow-up guide ring 16 for diverting the swirling hot-gas flow 18 emerging from the low-pressure turbine 10. For this purpose, the follow-up guide ring 16 comprises multiple blades 20 which are arranged in the annular chamber 14. In this case, the blades are arranged in the circumferential direction so as to be substantially uniformly spaced apart from one another, and/or symmetrical, in the annular chamber (not illustrated). It can be seen that the blade 20 has a leading edge 22 situated upstream and a trailing edge 40 situated downstream. In this case, the leading edge 22 is designed such that, in the direction of a radially externally situated housing wall 24 of the annular chamber 14, it runs so as to advance in the downstream direction. In the exemplary embodiment illustrated, the leading edge 22 is configured so as to run at an angle ε with respect to a radial line r that lies on a plane 38 formed perpendicular to the engine axis 26. In the exemplary embodiment illustrated, the angle ε is approximately 25°. It can however assume all values between 15° and 35°. The radial line r relative to the profile ax of the axial engine axis 26 forms the reference system for the determination of the angle ε. In the exemplary embodiment illustrated, the trailing edge 40 is likewise designed such that it runs so as to advance in the downstream direction. The angle ε is configured so as to be constant over the entire length of the leading edge 22. It is however also possible for said angle to vary in sections in the value range between 15° and 35°.

It can furthermore be seen that a radially outer end 28 of the blade 20 is connected to an inner side 32 of the radially externally situated housing wall 24 of the annular chamber 14. Also, a radially inner end 30 of the blade 20 is connected to an inner side 36 of a radially internally situated housing wall 34 of the annular chamber 14. In terms of engine construction, the housing wall 34 is normally understood to be the hub. Furthermore, it is clear that the annular chamber 14 of the outlet housing 12 is formed so as to be inclined from the low-pressure turbine 10 in the direction of the engine axis 26. This can be seen in FIG. 2 from the angle β which, in the reference system r/ax, is less than 0°. It can furthermore be seen that, owing to the configuration of the blades 20 of the follow-up guide ring 16, the radially internally situated housing wall 34 or hub of the outlet housing 12 is formed so as to be inclined further in the direction of the engine axis 26 than a similar housing wall 34′ or hub of the outlet housing 4, illustrated in FIG. 1, of a known aircraft engine.

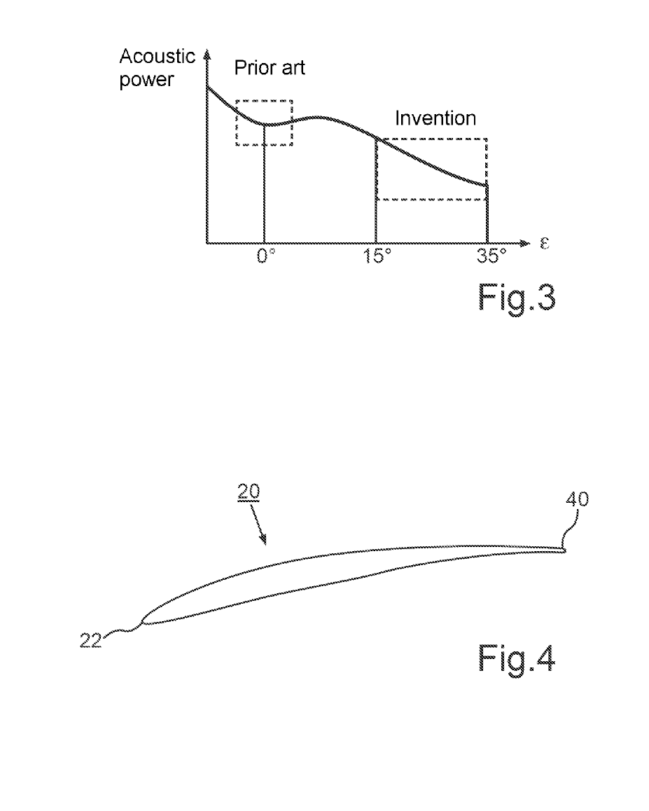

FIG. 3 shows an illustration of the profile of the acoustic power, generated by the interaction between the final rotor 42 of the low-pressure turbine 10 and the follow-up guide ring 16, in relation to the magnitude of the axially swept configuration (angle ε) of the leading edge 22 of the blade 20 of the follow-up guide ring 16. It can be seen that a significant reduction in acoustic power is attained in the angle range between 15° and 35°.

FIG. 4 shows an exemplary cross section of a blade 20 of the follow-up guide ring 16. It can be seen that the leading edge 22 is of rounded form in cross section. This correspondingly applies to the trailing edge 40, wherein furthermore, the blade 20 has a thickening in the cross section in the central region between the leading edge 22 and the trailing edge 40. It can furthermore be seen that the blade 20 has a slightly arched configuration in order to divert the swirling hot-gas flow 18 from the low-pressure turbine 10 at least in regions, and in so doing in particular at least partially eliminate the swirl from the hot-gas flow 18.

The values stated in the documents for characterizing specific properties of the subject matter of the invention are to be regarded as also being encompassed by the scope of the invention even within the scope of deviations—for example owing to measurement errors, system errors, weighing errors, DIN tolerances and the like. In particular, deviations of ±10% from the respective value are to be regarded as also being encompassed by the disclosure.

While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

To sum up, the present invention provides:
1. An aircraft engine having an outlet housing (12) arranged downstream of a low-pressure turbine (10) and having at least one follow-up guide ring (16) which is arranged within an annular chamber (14) of the outlet housing (12) and which serves for diverting a swirling hot-gas flow (18) emerging from the low-pressure turbine (10). The follow-up guide ring (16) comprises at least one blade (20) which is arranged in the annular chamber (14) and has an upstream leading edge (22), the leading edge (22) being designed such that, from its radially inner end in the direction of a radially externally situated housing wall (24) of the outlet housing (14), it runs so as to advance in the downstream direction The leading edge (22) also is configured so as to run at an angle ε of from 15° and 35° with respect to a radial line r that lies on a plane (38) formed perpendicular to an engine axis (26).
2. The aircraft engine of item 1, wherein the angle ε is 20° to 30°, in particular about 25°.
3. The aircraft engine of any one of items 1 and 2, wherein a ratio of a maximum axial extent to a maximum radial extent of the at least one blade (20) of the follow-up guide ring (16) is less than 0.6, preferably about 0.5.
4. The aircraft engine of any one of items 1 to 3, wherein a ratio of a number of blades (20) of the follow-up guide ring (16) to a number of blades of a rotor (42), which is directly adjacent to the follow-up guide ring (16) in an upstream direction, of the low-pressure turbine (10) is greater than 0.3, e.g., greater than 0.5, greater than 0.6, or about 0.7.
5. The aircraft engine of any one of items 1 to 4, wherein the blades (20) of the follow-up guide ring (16) have no supply lines.
6. The aircraft engine of any one of items 1 to 5, wherein a profile axis of the annular chamber (14) of the outlet housing (12) is formed so as to be inclined from the low-pressure turbine (10) in the direction of the engine axis (26).
7. The aircraft engine of item 6, wherein, in the reference system of the radial line r with respect to a profile ax of the engine axis (26), an angle of inclination β of the profile axis of the annular chamber (14) of the outlet housing (12) is less than 0°.
8. The aircraft engine of any one of items 1 to 7, wherein the blade (20) is of profiled form in cross section.
9. The aircraft engine of item 8, wherein the leading edge (22) of the blade (20) is of rounded form.
10. The aircraft engine of any one of items 1 to 9, wherein a radially outer end (28) of the blade (20) is arranged at an inner side (32) of the radially externally situated housing wall (24) of the outlet housing (14), and/or a radially inner end (30) of the blade (20) is arranged at an inner side (36) of a radially internally situated housing wall (34) of the outlet housing (14).
11. The aircraft engine of any one of items 1 to 10, wherein at least two blades (20) are arranged symmetrically in the annular chamber (14) in order to form the follow-up guide ring (16).
12. The aircraft engine of any one of items 1 to 11, wherein the angle ε is constant over the entire length of the leading edge (22) or varies in sections.

### LIST OF REFERENCE SIGNS

1 Low-pressure turbine

2 Rotor

3 Engine axis

4 Outlet housing

5 Annular chamber

6 Follow-up guide ring

7 Blade

8 Leading edge

9 Hot-gas flow

10 Low-pressure turbine

12 Outlet housing

14 Annular chamber

16 Follow-up guide ring

18 Hot-gas flow

20 Blade

22 Leading edge

24 Housing wall

26 Engine axis

28 Blade end

30 Blade end

32 Inner side

34 Housing wall

36 Inner side

38 Plane formed perpendicular to the engine axis

40 Trailing edge

42 Rotor

ax Engine axis profile

r Radial line

What is claimed is:

1. An aircraft engine, wherein the aircraft engine comprises an outlet housing arranged downstream of a low-pressure turbine and at least one follow-up guide ring which is arranged within an annular chamber of the outlet housing and serves for diverting a swirling hot-gas flow emerging from the low-pressure turbine, the follow-up guide ring comprising at least one blade which is arranged in the annular chamber and comprises an upstream leading edge, which leading edge is designed such that, from its radially inner end in a direction of a radially externally situated housing wall of the outlet housing, it runs so as to advance in the downstream direction, the leading edge being configured so as to run at an angle ε of from 15° to 35° with respect to a radial line r that lies on a plane formed perpendicular to an engine axis.

2. The aircraft engine of claim 1, wherein the angle ε is from 20° to 30°.

3. The aircraft engine of claim 1, wherein the angle ε is about 25°.

4. The aircraft engine of claim 1, wherein a ratio of a maximum axial extent to a maximum radial extent of the at least one blade of the follow-up guide ring is less than 0.6.

5. The aircraft engine of claim 1, wherein a ratio of a maximum axial extent to a maximum radial extent of the at least one blade of the follow-up guide ring is about 0.5.

6. The aircraft engine of claim 1, wherein a ratio of a number of blades of the follow-up guide ring to a number of blades of a rotor that is directly adjacent to the follow-up guide ring in an upstream direction of the low-pressure turbine is greater than 0.3.

7. The aircraft engine of claim 1, wherein a ratio of a number of blades of the follow-up guide ring to a number of blades of a rotor that is directly adjacent to the follow-up guide ring in an upstream direction of the low-pressure turbine is greater than 0.5.

8. The aircraft engine of claim 1, wherein a ratio of a number of blades of the follow-up guide ring to a number of blades of a rotor that is directly adjacent to the follow-up guide ring in an upstream direction of the low-pressure turbine is greater than 0.6.

9. The aircraft engine of claim 1, wherein a ratio of a number of blades of the follow-up guide ring to a number of blades of a rotor that is directly adjacent to the follow-up guide ring in an upstream direction of the low-pressure turbine is about 0.7.

10. The aircraft engine of claim 1, wherein blades of the follow-up guide ring comprise no supply lines.

11. The aircraft engine of claim 1, wherein a profile axis of the annular chamber of the outlet housing is formed so as to be inclined from the low-pressure turbine in a direction of the engine axis.

12. The aircraft engine of claim 11, wherein, in a reference system of the radial line r with respect to a profile ax of the engine axis, an angle of inclination β of the profile axis of the annular chamber of the outlet housing is less than 0°.

13. The aircraft engine of claim 1, wherein the blade is of profiled form in cross section.

14. The aircraft engine of claim 13, wherein a leading edge of the blade is of rounded form.

15. The aircraft engine of claim 1, wherein a radially outer end of the blade is arranged at an inner side of the radially externally situated housing wall of the outlet housing, and/or a radially inner end of the blade is arranged at an inner side of a radially internally situated housing wall of the outlet housing.

16. The aircraft engine of claim 1, wherein at least two blades are arranged symmetrically in the annular chamber in order to form the follow-up guide ring.

17. The aircraft engine of claim 1, wherein the angle ε is constant over the entire length of the leading edge.

18. The aircraft engine of claim 1, wherein the angle ε varies in sections.
